(19) United States
(12) Patent Application Publication
(10) Pub. No.: US 2021/0311322 A1
(43) Pub. Date: Oct. 7, 2021

(54) Headset for Illuminating Retroreflective Items

(71) Applicants: Jonah Belanger, Chicago, IL (US); Ryan Fitzpatrick Richards, Chicago, IL (US); Christopher Sossong, Duxbury, MA (US)

(72) Inventors: Jonah Belanger, Chicago, IL (US); Ryan Fitzpatrick Richards, Chicago, IL (US); Christopher Sossong, Duxbury, MA (US)

(21) Appl. No.: 17/223,913

(22) Filed: Apr. 6, 2021

Related U.S. Application Data
(60) Provisional application No. 63/005,479, filed on Apr. 6, 2020.

(51) Int. Cl. G02C 5/00; F21V 21/084; F21V 21/088; F21V 21/30

(52) U.S. Cl. CPC G02C 5/001; F21V 21/084; F21V 23/0414; F21V 21/30; F21V 21/0885

(57) ABSTRACT

A headset for illuminating retroreflective items is disclosed herein. The headset is comprised of glasses, goggles, or other head-mounted assembly with light arrays mounted thereon. The lighting from the light arrays can be directed at a surface which illuminates when a light is directed at it, such as a retroreflective material. The present disclosure may advantageously be used with balls, articles of clothing, masks, paint, and numerous other items that may be covered, all or partially, with a retroreflective coating or layer, to create a unique user experience, particularly when the headset and retroreflective items are used in combination under low light or no light conditions.

### BACKGROUND

### Technical Field

The present disclosure relates generally to headsets having lighting mounted thereon. More particularly, the present disclosure relates to a headset comprising glasses, goggles, or other types of head-mounted assembly with lighting mounted thereon for illuminating materials or surfaces that appear to glow when lighting is directed towards them, such as items or materials covered, all or partially, by a retroreflective coating or layer.

### Description of Related Art

Electric powered headlamps have been around since the early 1900s with the advent of electricity during this time. These early headlamps consisted of a light built into or attached to a helmet that was worn by coal miners to illuminate areas for underground mining.

Over the years different versions of the early headlamp have been developed for various types of uses, such as caving, orienteering, hiking, skiing, backpacking, camping, mountaineering, mountain biking, search and rescue, and other types of work or activities requiring hand-free lighting. Battery powered headlamps, halogen headlamps, and LED headlamps are known in the art.

Headlamps that are used in various activities today are used primarily to illuminate a dark area for the user. The headlamps of the prior art are bulky and may need to be attached to a helmet in order to remain in place on the user's head while the user is engaging in strenuous activities.

Therefore, what is needed is a headset for illuminating retroreflective items having the following characteristics and benefits over the prior art.

### SUMMARY

The subject matter of this application may involve, in some cases, interrelated products, alternative solutions to a particular problem, and/or a plurality of different uses of a single system or article.

It is an object of the present disclosure to provide a headset with lighting mounted thereon to illuminate dark areas and materials, objects, or surfaces in low or dimly lit conditions. It is another object of the present disclosure to provide a headset for illuminating items covered, wholly or partially, with a retroreflective coating or layer, such as retroreflective balls, articles of clothing, masks, paint, and various other items, materials, or surfaces, while providing a unique user experience that can be shared with spectators and observers in-person or on the internet. It is another object of this disclosure to allow participants in a sports event to use at least one retroreflective item under low light or no light conditions, such as to play a game indoors with limited lighting or outside during the night, which may allow for added play value for event participants and spectators.

In one aspect of the present disclosure, a pair of goggles or a pair of glasses may be connected to either a strap or a pair of arms, and a plurality of light arrays may be mounted to at least one of the goggles, the glasses, the strap, or the arms.

In another aspect of the present disclosure, a pair of goggles or a pair of glasses may be connected to either a strap or a pair of arms, and a plurality of light arrays containing at least one light may be mounted to at least one of the goggles, the glasses, the strap, or the arms. In this aspect of the present disclosure, a camera may be connected to the pair of goggles or the pair of glasses, and a radio frequency transmitter or transceiver may be implanted within either the goggles, the glasses, or the light arrays for establishing a wireless data connection with a remote storage device.

In yet another aspect of the present disclosure, a method of using the headset from other aspects of the present disclosure may be utilized. The method of this aspect of the present disclosure may comprise the steps of acquiring the headset; placing the headset on a user's head; turning at least one light on; activating the camera; providing a retroreflective item; and directing the camera toward the retroreflective item by turning the user's head toward the item.

It should be understood that the various elements of the present disclosure utilized in different aspects may be of varying sizes and shapes without straying from the scope of the present disclosure.

### BRIEF DESCRIPTION OF THE DRAWINGS

FIG. 1 provides a perspective view of an embodiment of the present disclosure.

FIG. 2 provides a perspective view of another embodiment of the present disclosure.

FIG. 3 provides a perspective view of yet another embodiment of the present disclosure.

FIG. 4 provides a perspective view of another embodiment of the present disclosure.

FIG. 5 provides a perspective view of a user utilizing an embodiment of the present disclosure.

FIG. 6 provides another perspective view of a user utilizing another embodiment of the present disclosure.

FIG. 7 provides a perspective view of another embodiment of the present disclosure.

FIG. 8 provides a perspective view of several embodiments of the present disclosure.

FIG. 9 provides a perspective view of an embodiment of the present disclosure interacting with a retroreflective item.

FIG. 10 provides another perspective view of an embodiment of the present disclosure interacting with a retroreflective item.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a headset for illuminating dark areas and objects within those areas. More specifically, the present disclosure concerns a headset for illuminating items covered, wholly or partially, with a retroreflective coating or layer. The embodiments described herein may allow the user to illuminate certain surfaces or objects and record or photograph the same for sharing in-person or over the internet.

In some embodiments the headset comprises a pair of goggles connected to an adjustable strap that may be made from an elasticized material. The adjustable strap may have a strap adjuster for adjusting the length of the strap to fit varying head sizes of users. In some embodiments, light arrays may be mounted to the strap, the goggles, or both simultaneously. The light arrays may be comprised of a mounting clip that may be clipped onto the strap, the goggles, or both simultaneously. Alternatively, in some embodiments the light arrays may be integrated within the strap, the goggles, or both. For example, the light arrays may be integrated within the strap by having a keeper-band that the strap of the goggles may be slid through. As another example of integration, the light arrays may be connected to the goggles by a hinge connected to both the goggles and the arrays. Some embodiments may utilize both methods of integration; however, the methods of integration are not limited solely to the aforementioned options of integration.

In other embodiments the headset comprises a pair of glasses connected to a pair of arms. The light arrays may be mounted to the glasses or the arms by a mounting screw or by being integrated into the structure of the glasses, arms, or both simultaneously. In the embodiments that utilize a mounting screw, the light arrays may comprise an internally threaded connection member for engaging the mounting screw after the mounting screw is screwed through either the frame of the glasses or the arms. In the embodiments where the light arrays are integrated into the structure of the glasses, arms, or both simultaneously, the glasses, the arms, or a portion of both may have been produced with a plastic mold in the shape of the light arrays. While plastic molding may be one method of integration, it is not the sole method. In some embodiments a cord may be attached to the arms of the glasses. In the embodiments of the headset utilizing cord, the cord may comprise a cord adjuster for adjusting the length of the cord to better secure the headset to a user's head, regardless of the varying head sizes of users. In other embodiments, the headset may comprise glasses connected to a strap that may be adjustable and/or elasticized. In yet other embodiments, the headset may comprise at least one light array attached to a hat, helmet, or headband.

In most embodiments, the light arrays comprise at least one light. The lights may be electrically powered through use of a rechargeable or a replaceable battery, and the lighting may have a light-emitting diode (LED) as the source of the light; however, other types of electric power and lighting may be used. In the embodiments where the battery for the light arrays are rechargeable, a USB cable may be used to charge the batteries. The charging ports of the light arrays may be compatible with various types of USB configurations, including micro USB; however, different types of charging ports, cables, and charging methods may be utilized. In some embodiments, the light arrays comprise a plurality of lights directing light away from the headset at various directions and angles. For example, one embodiment utilizes three lights, one directed forward, one directed to the side at an angle, and one directed downward at an angle. The plurality of lights may provide a single beam angle or multiple beam angle lighting; however, other lighting configurations may be used to also provide a broad and wide angle lighting projection.

In some embodiments, broad and wide angles of lighting projection may be accomplished through use of multiple lights, which may have an LED source, within a single light lens. The plurality of lights within the single light lens may provide a single beam angle or multiple beam angle lighting, depending on the embodiment. The plurality of lights within the singular lens may project light away from the headset at various directions and angles. For example, within a single lens, there may be a light directed forward, two lights directed to the side at an angle, one light directed upward at an angle, and one light directed downward at an angle. Still, other lighting configurations and amounts of lights may be used within a singular lens.

In most embodiments, there are various light modes for users to select. In some embodiments, the user may select and/or toggle through these modes by pressing or interacting with various elements on the headset. In some embodiments, there may be only a couple of light modes. For example, the light modes may be simply ‘OFF’ or ‘ON’. In other embodiments, there may be several different light modes. For example, the light modes in other embodiments may be ‘OFF’, ‘LOW POWER’, ‘MEDIUM POWER’, ‘HIGH POWER’, and ‘ALL LIGHTS ON’. In the ‘OFF’ mode, the lights may be powered off, wherein no electric current is flowing through the source of the light. In all other modes, some amount of electric current may be flowing through the source of the lights. The ‘LOW POWER’ mode corresponds to a low brightness of light being emitted from the source, which is intended for viewing objects that are relatively close to the user. The ‘MEDIUM POWER’ mode corresponds to a medium brightness of light being emitted from the source, which is intended for viewing objects that are approximately mid-distance from the user. The ‘HIGH POWER’ mode is typically used in embodiments of the present disclosure that utilize at least one high beam attached to some part of the headset. For example, a high beam may be attached to the frame of the goggles or the glasses, or a high beam may be attached to the arms or the light arrays of the headset, depending on the embodiment. In most embodiments that utilize the ‘HIGH POWER’ mode, the mode is intended for maximum distance viewing, which usually corresponds to the high beam being enabled/powered on and power being reduced or diverted away from lights that provide peripheral visibility for the user, such as lights directed away from either side of the headset at an angle. The ‘ALL LIGHTS ON’ mode may power every light in the embodiment on, and each light may appear to emit light with an equal brightness. In the embodiments that use a high beam, the ‘AIL LIGHTS ON’ mode may power the high beam with equal power to the lights of the light array. It should be expressly understood that various configurations and amount of light modes may be utilized across various embodiments, and the light modes of the present disclosure are not to be limited solely to the aforementioned configurations and number of modes.

In some embodiments, the high beam may provide greater visibility when viewing things at a distance because of the beam angle and beam pattern of the light emitted from the high beam. For example, the high beam may emit light at a relatively small beam angle/width, typically less than 30°, in most embodiments approximately 10°, which produces a precise spot beam pattern where the light emitted from the high beam appears to travel far away from the user in a relatively straight line, providing the user with the maximum distance visibility. Contrarily, light emitted from the light arrays of the headset may be emitted at a larger beam angle than the light emitted from the high beam, which may provide a different beam pattern than the light emitted from the high beam. For example, the lights from the light array may emit light at a beam angle/width, in most embodiments greater than 30°, which produces a flood beam pattern wherein the light emitted from the light arrays appears to light up the entire area at a medium distance from the user, giving the user moderate distance visibility and greater peripheral visibility. The high beam and the light arrays may produce light at various beam angles, producing a variety of beam patterns, beam widths, or combinations of patterns and widths, depending on the embodiment. Some embodiments of the high beam and the light arrays may allow the user to adjust the beam width on of light being emitted from either the high beam or the light arrays. For example, the high beam, or the light arrays, or both may comprise a rotatable member that adjusts the beam width/angle between approximately 0° and 180°; however, other methods of adjusting beam widths may be used, depending on the embodiment.

Some embodiments of the headset comprise a camera. The camera may be used for recording, taking photos, or both. The camera may be a 4K/1080P camera with Bluetooth® or wireless capabilities; however, other types of cameras may be used. In most embodiments, the camera may be secured to the bridge of the frame of the goggles or the glasses. In some embodiments, the camera may be powered by a battery within the camera. In other embodiments, the camera may be electrically connected to a power source within an element of the headset, such as a battery within the frame of the goggles or the glasses, or a battery within the light arrays; however, other methods of powering the camera may be used. Some embodiments of the headset may also comprise a GPS receiver or other location indicator, a processor, a radio frequency transmitter/transceiver for establishing a wireless data connection, such as Bluetooth®, and/or a data storage unit. The GPS receiver or other location indicator, the radio frequency transmitter/transceiver, and/or the data storage unit may be mounted to or within an element of the headset. For example, the GPS receiver or location indicator may be mounted on a light array, and both the data storage unit and the radio frequency transmitter/transceiver may be secured and electrically connected within the frame of the goggles or the glasses. It should be expressly noted that the aforementioned example is just one way the GPS receiver or location indicator, the radio frequency transmitter/transceiver, and the data storage unit may engage with the headset; however, other methods of engagement may be used, depending on the embodiment.

In the embodiments that utilize a camera or a GPS or other location indicator, virtual data, such as video data, photo data, or location data may be produced that requires storage. As previously mentioned, some embodiments of the headset may contain a data storage unit within the headset where such data can be stored. Alternatively, or in addition, data may be transmitted wirelessly through a wireless data connection, such as Bluetooth®, from the headset to a remote storage device, such as a server, a smartphone, or a tablet, and the like, which may contain additional units where data can be stored.

In most embodiments of the headset, there are numerous functions that can be performed by the headset that require some options by which the user can operate or control the various functions. For example, in every embodiment, the headset comprises at least one light that requires a way for turn ng the light on or off. In some embodiments, the headset has various light modes, and a way for selecting the user's preferred mode of operation must be provided. Moreover, in other embodiments, a way for activating the camera and establishing the wireless data connection between the headset and the remote storage device must be provided to the user. In some embodiments, the way for powering the lights on or off may be accomplished through use of a power button or power switch. In other embodiments, a way for increasing or decreasing the intensity of the light emitted from the headset or for selecting between various light modes may be provided to user through use of a positive intensity adjuster and a negative intensity adjuster, wherein the positive intensity adjuster may increase the intensity of light emitted from the headset or select a higher light mode and, conversely, the negative intensity adjuster may decrease the intensity of the light emitted from the headset or select a lower light mode. Alternatively, a toggle, which may be a switch, a sliding adjuster, or a touch activated sensor, may be used to adjust the intensity of the light emitted from the headset or select the light mode. In some embodiments, a way for activating the camera and establishing the wireless data connection may be provided in the form of a camera button and a wireless data connection key, respectively. The camera button may perform multiple functions depending on how many times or for how long the button is pressed. For example, pressing the camera button once may activate the camera, pressing the button while the camera is activated may cause the camera to record, and holding the button while the camera is activated may cause the camera to turn off. In some embodiments, the wireless data connection key may be used in combination with a wireless data connection indicator light, wherein the user may press the wireless data connection key to establish a wireless data connection between the headset and a remote storage device, and the wireless data connection indicator light illuminates when the wireless data connection has been established. Once the wireless data connection is established, some embodiments may use this connection as a way of controlling the camera and its functions, alternatively or in addition to the camera button. For example, some embodiments may use an application on a smartphone or tablet in combination with the wireless data connection to control the functions of the camera. Each of the physical elements mentioned in this paragraph may also be utilized in touch sensor form. For example, the wireless data connection key references a physical structure (i.e., a key or a button); however, the wireless data connection key may also refer to a touch sensor version of the physical structure. In other words, it should be expressly understood that the aforementioned physical structures/elements are not the sole ways for accomplishing any of the given functions of the headset or its components, and more or less options may be provided, depending on the embodiment. For example, the GPS or other location indicator may be controlled by a GPS button or by an application in combination with a wireless data connection. It should also be noted that the power button or switch, the intensity adjusters or the toggle, the wireless data connection key, the wireless data connection indicator light, the camera button or an application may be used alternatively or additionally, depending on the embodiment.

In some embodiments, the light arrays may comprise a power button or switch, intensity adjusters or a toggle, a wireless data connection key and indicator light, and a camera button. In other embodiments, the headset may comprise glasses or goggles connected to arms, wherein the arms may further comprise a control board thereon. For example, the arms may define a control board shape at the end of the arms where the arms are connected to the goggles or the glasses. The end of the arms that defines the control board may be wider than the end of the arms not defining the control board, and the control board may protrude slightly from the plane of the arms. The control board may comprise a power button or switch, intensity adjusters or a toggle, a wireless data connection key and indicator and a camera button. In other embodiments, a remote controller may be wireless connected to the headset through use of infrared lighting or other wireless technology. The remote controller may comprise a power button or switch, intensity adjusters or a toggle, a wireless data connection key and indicator light, and a camera button. It should be expressly noted that various embodiments may utilize different configuration of the aforementioned control options on the light arrays, the control board, or the remote controller. For example, in some embodiments, the light arrays may comprise the power button or switch, and the control board may comprise intensity adjusters or a toggle, and a wireless data connection key and indicator light, and a wirelessly connected camera may be activated and controlled through use of an application. Another example a potential configuration of the control option is that the light arrays may comprise a power button or switch and a wireless data connection indicator light, and the control board may comprise intensity adjusters or a toggle, a wireless data connection key, and a camera button that is touch sensor activated. The aforementioned examples are just to illustrate that there are a vast number of potential embodiments regarding what elements of the headset or remote controller contain the control options for the functions of the headset and what structures accomplish those functions, and the present disclosure is not limited to only those embodiments expressly mentioned in the specification.

In another embodiment of the present disclosure, a method or system of using the headset is disclosed. The system comprises multiple steps that may include any combination of the following: acquiring the headset; placing the headset on a user's head; turning at least one light on; activating the camera; providing a retroreflective item; directing the camera toward the retroreflective item by turning the user's head toward the item; establishing a wireless data connection between the camera and a remote storage device; recording or photographing the retroreflective item with the camera; transmitting data to a remote storage device; and/or utilizing a remote controller perform at least one of the aforementioned step. Once data, such as video or photo data, is sent from the headset to a remote storage device, the data may be further uploaded or posted to the internet on a cloud or server based social media distribution site, where the videos or images can be shared with spectators and observers or the general internet community.

In most embodiments, various items, surfaces, or materials having a retroreflective coating or layer may be used in combination with the headset as described herein for a unique user experience. These various items include, but are not limited to the following: sports balls, sports equipment, sports infrastructure, clothing, such as sweatshirts and masks, site infrastructure, or other items that may need to be highlighted for identification of involved persons. Items that are covered wholly or partially will appear to glow to the user and the camera because of the nature of the retroreflective coating. The retroreflective coating directs light back at its source at the same angle that the light hit the retroreflective coating. When light being directed back towards the headset is within the peripheral field of vision or view of the user's eyes or the camera, the retroreflective item being viewed or recorded will appear to glow. In addition to making retroreflective items appear to glow, the headset may also generally illuminate dark areas. Therefore, the present disclosure may enable enhanced visibility in low to no light conditions indoors or outdoors and may allow participants to play sports when at least one retroreflective item is a sports ball, such as a basketball or soccer ball, outside at night or other low light times of day, which may provide added play value for participants and spectators alike.

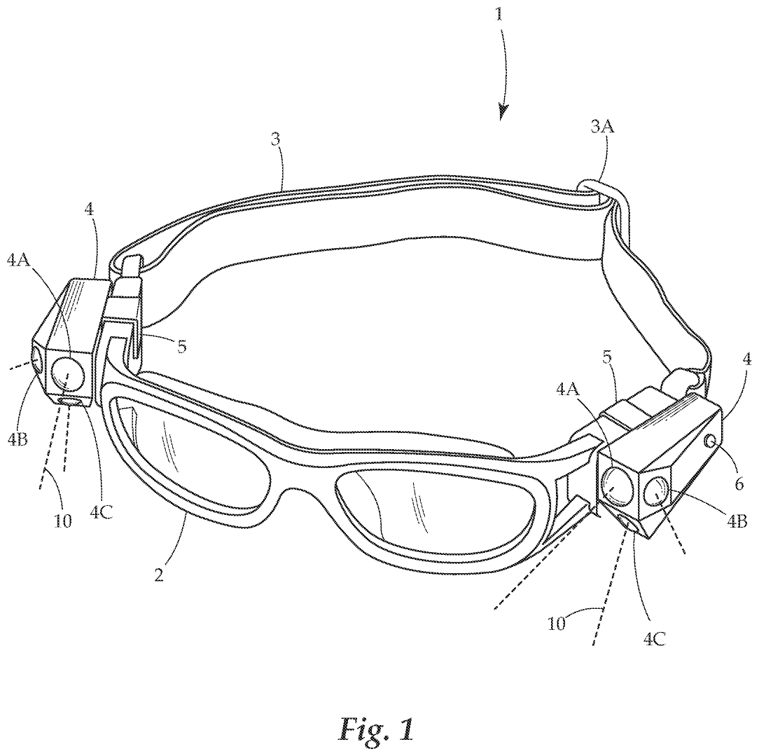

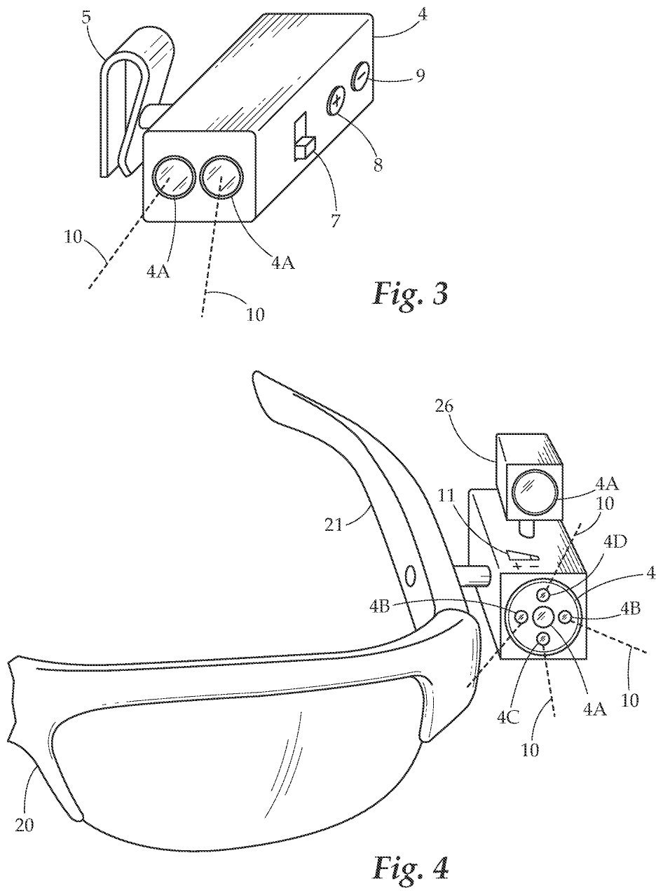

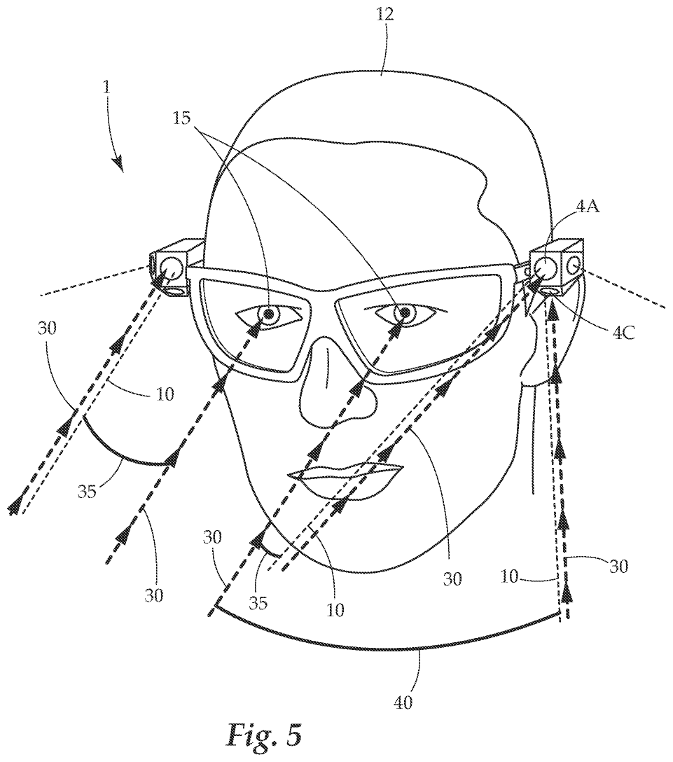

Turning now to FIG. 1, which shows an embodiment of the headset 1. In this embodiment, the headset 1 is comprised of a pair/set of goggles 2, which are connected to a strap 3 having a strap adjuster 3A. The strap 3 holds the headset 1 in place on a user's head 12 (shown in FIG. 5), and strap adjuster 3A adjusts the length of the strap 3 to allow the headset 1 to be secured to a user's head 12 (shown in FIG. 5) regardless of varying head sizes of users. Headset 1 is further comprised of a pair/set of light arrays 4, which may be mounted on the headset 1 by securing mounting clips 5 to either the goggles 2, strap 3, or both goggles 2 and strap 3, simultaneously. In the embodiment shown in FIG. 1, each light array 4 utilizes three lights 4A, 4B, and 4C. One light 4A is directed forward, another light 4B is directed at a side angle, and yet another light 40 is directed at a downward angle. Each light array 4 may comprise a power button 6 or switch 7 (shown in FIG. 3) to turn lights 4A, 4B, and 4C on or off. When turned on, each light 4A, 4B, and 4C emits light photons/rays 10 in the direction that the light 4A, 4B, or 4C is directed.

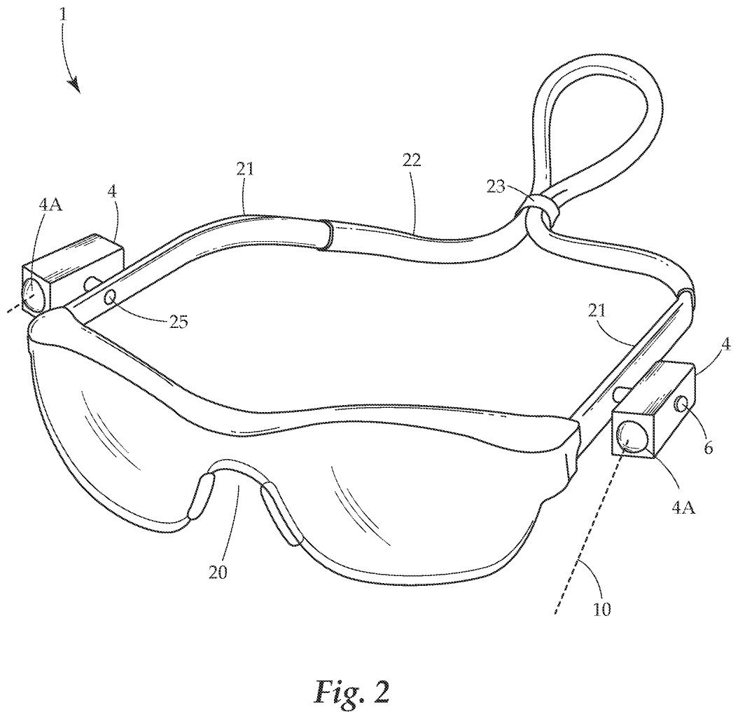

FIG. 2 shows another embodiment of the headset 1. In this embodiment, the headset 1 is comprised of a pair of glasses 20, having a pair of arms 21 connected to cord 22 having cord adjuster 23. Similar to the strap 3 (shown in FIG. 1), the cord 22 holds the headset 1 in place on a user's head (shown in FIG. 5), and cord adjuster 23, similar to strap adjuster 3A (shown in FIG. 1), adjusts the length of the cord 22 to allow the headset 1 to be secured to a user's head 12 (shown in FIG. 5) regardless of varying heads sizes of users. FIG. 2 also shows a plurality of light arrays 4, each mounted to the headset 1 by a mounting screw 25. In the embodiment shown in FIG. 2, each light array 4 utilizes one light 4A directed forward. Each light array 4 may comprise a power button 6 or switch 7 (shown in FIG. 3) to turn light 4A on or off. When powered on, each light 4A emits light photons/rays 10 in the forward direction.

FIG. 3 shows an embodiment of a light array 4. This embodiment is connected to a mounting clip 5 and utilizes two lights 4A directed forward. This embodiment also comprises power switch 7 for turning lights 4A on and off. Positive intensity adjuster 8 and negative intensity adjuster 9 may be used to either increase or decrease, respectively, the intensity of the light photons/rays 10 being emitted from the lights 4A.

FIG. 4 shows an embodiment of the headset 1 comprising a pair glasses 20 connected to arms 21 (only one shown), wherein the arms 21 are not connected to a cord 22 (shown in FIG. 2). In this embodiment a light array 4 is mounted on both arms 21 (only one is shown). This light array 4 has a single lens that houses at least four different types of lights: light 4A directed forward; lights 4B directed towards opposite sides of light array 4 at an angle; light 4C directed downward at an angle; and light 4D directed upward at an angle. High beam 26, comprising a powerful light 4A directed forward for longer distance views, is mounted on light array 4. High beam 26 may be both structurally and electrically connected to light array 4. Light array 4 has a toggle 11 that allows the user to toggle between multiple different light modes (not shown). When the lights 4A, 4B, 4C, or 4D are powered on, they emit light photons/rays 10 away from light array 4 in the direction and at the angle that the lights 4A, 4B, 4C, or 4D are directed.

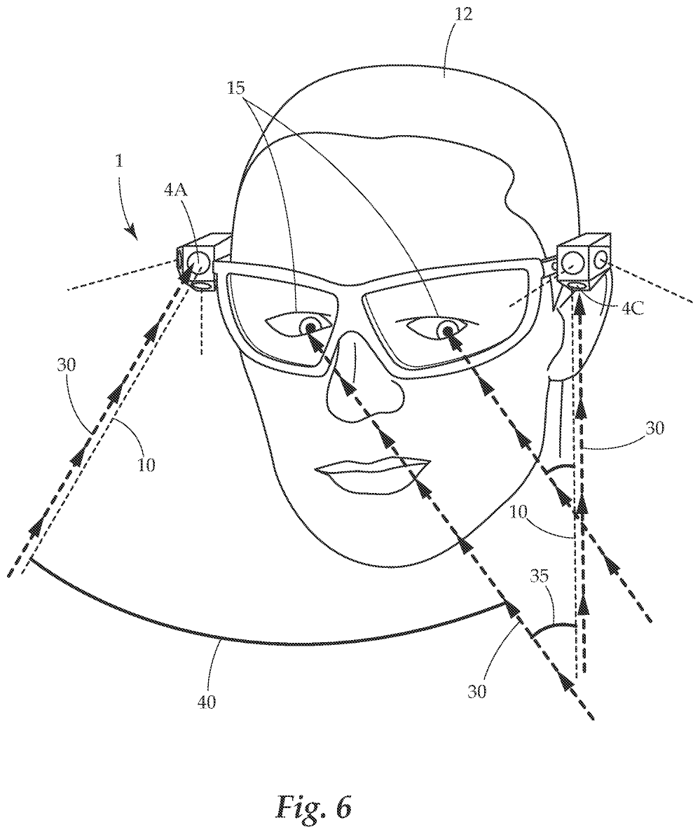

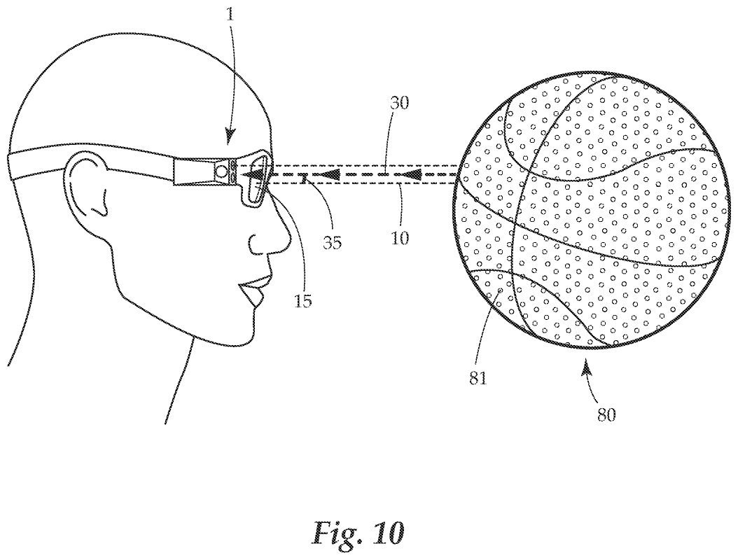

FIGS. 5 and 6 show an embodiment of the headset 1 on a user's head 12. FIG. 5 shows the user's eyes 15 directed forward, and FIG. 6 shows the user's eyes 15 directed downward. When forward directed light photons/rays 10 being emitted from light 4A hit a retroreflective item 80 (shown in FIG. 10) the light photons/rays 10 bounce off the retroreflective item 80 (shown in FIG. 10) as returning light photons/rays 30 at the same angle and opposite direction as the incident light photons/rays 10. In other words, as shown in both FIGS. 5 and 6, returning light photons/rays 30 are directed backward towards light 4A and directed upward towards light 4C. When the user's eyes 15 are directed in the same direction as the incident light photons/rays 10, the user is able to see returning light photons/rays 30 because the small observation angle 35 is within the peripheral field of vision of the user's eyes 15. Alternatively, when the user's eyes 15 are directed in a different direction than the incident light photons/rays 10, the user may not be able to see returning light photons/rays 30 because the large observation angle 40 may be outside of the peripheral field of vision of the user's eyes 15. As shown in FIG. 5, the user is able to see returning light photons/rays 30 being directed back towards light 4A; however, the user may not be able to see returning light photons/rays 30 being directed upward towards light 4C. Alternatively, when the user's eyes 15 are facing downward, as shown in FIG. 6, the user is able to see returning light photons/rays 30 being directed upward towards light 4C, and the user may not be able to see returning light photons/rays 30 being directed back towards light 4A.

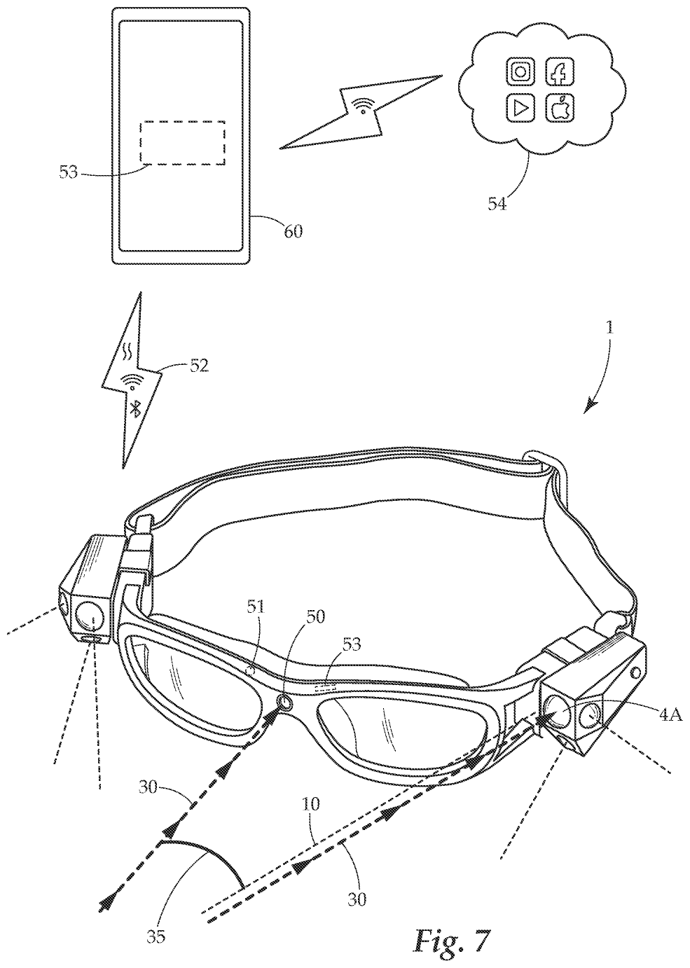

FIG. 7 shows an embodiment of the headset 1 with camera 50 mounted on the headset. Camera 50 may function as a video camera 50, a still camera 50, or both simultaneously. The camera 50 may of may not have wireless capability. Similar to a user's eyes 15 (shown in FIG. 5), camera 50 will be able to record and/or take pictures of a retroreflective item 80 (shown in FIG. 10) that is located where the camera 50 is directed incident light photons/rays 10 bouncing off the retroreflective item 80 (shown in FIG. 10) and returning back to light 4A as returning light photons/rays 30 are within the small observation angle 35 that is within the field of view of the camera. In the embodiment shown in FIG. 7, a location indicator 51 is mounted within the headset 1. In other embodiments (not shown), the location indicator 51 may be mounted on the outside of the headset 1. A wireless data connection 52, such as Bluetooth®, or other radio frequency transmitter/transceiver is used to transfer location data, video data, and any other data to and/or from headset 1 (virtual data not represented) to a remote storage device 60 (represented as a smartphone). In some embodiments, a data storage unit 53 may be located within or on headset 1 to store recorded information, such as location data, video data, and the like. As shown in the embodiment of FIG. 7, a data storage unit 53 is located both within the headset 1, and within the remote storage device 60. Virtual data may be transferred, streamed, posted, and the like from remote storage device 60 to a cloud or server based social media distribution site 54. Alternatively, virtual data may be transferred, streamed, or posted to a social media distribution site 54 directly from the headset 1 (not shown).

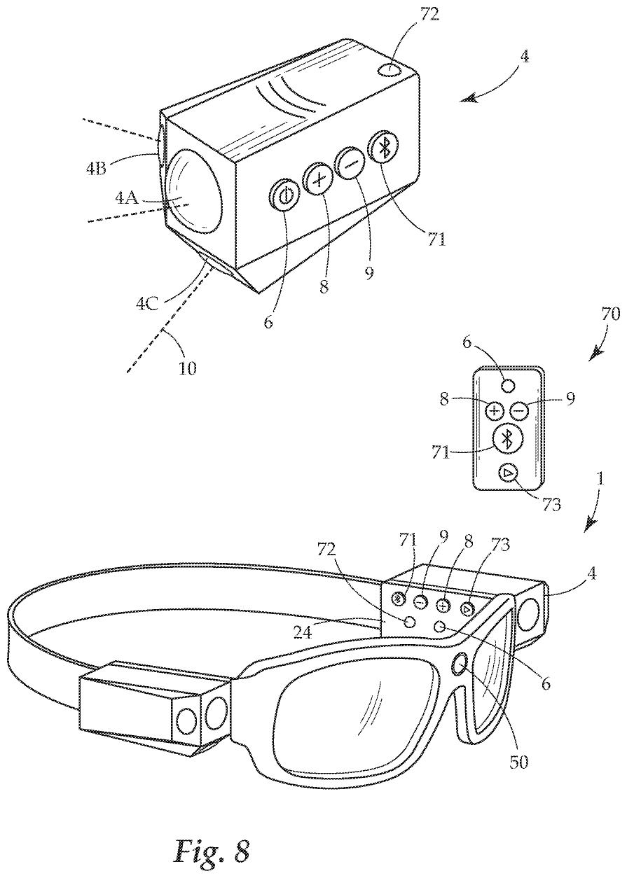

FIG. 8 shows several different embodiments of the present disclosure. FIG. 8 shows light array 4 having power button 6, positive intensity adjuster 8, negative intensity adjuster 9, wireless data connection key 71, and wireless data connection indicator light 72. Power button 6 turns lights 4A, 4B, and 4C on or off. Positive intensity adjuster 8 and negative intensity adjuster increase and decrease, respectively, the intensity of light photons/rays 10 that may be emitted from lights 4A, 4B, and 4C. Wireless data connection key 71 turns the wireless data connection 52 (shown in FIG. 7) between the headset 1 and remote storage device 60 (shown in FIG. 7) on and off. When a wireless data connection (shown in FIG. 7) established the wireless data connection indicator light 72 will illuminate. FIG. 8 also shows an embodiment of a remote controller 70 that may be wirelessly connected to the headset 1 and is comprised of power button 6, positive intensity adjuster 8, negative intensity adjuster 9, wireless data connection key 71, and camera button 73. Camera button 73 is used for the embodiments of the headset 1 that utilize a camera 50. Camera button 73 may allow the user to record video, take photos, or both, depending on the embodiment. Lastly, FIG. 8 shows an embodiment of the headset 1 having a control board 24 which may be electrically or wirelessly connected to light array 4 and camera 50. The control board 24 is comprised of power button 6, positive intensity adjuster 8, negative intensity adjuster 9, wireless data connection key 71, wireless data connection indicator light 72, and camera button 73. In each embodiment shown in FIG. 8, the power button 6, the positive intensity adjuster 8, the negative intensity adjuster 9, the wireless data connection key 71, the wireless data connection indicator light 72, and the camera button 73 all serve the same function, and each may be used alternatively or simultaneously depending on the embodiment.

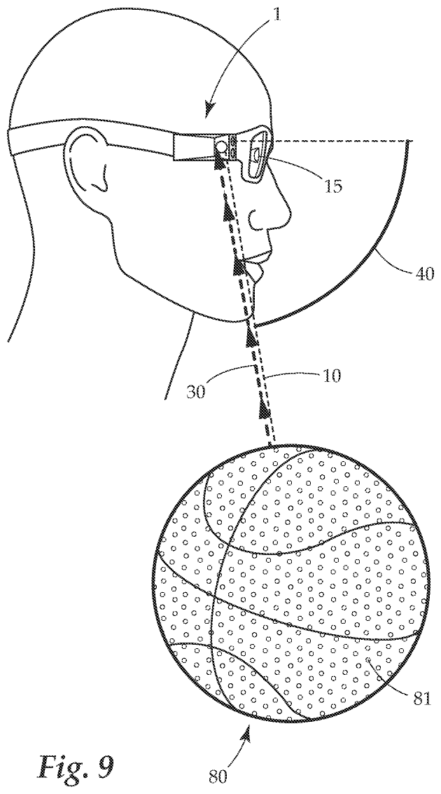

FIGS. 9 and 10 show how an embodiment of the headset 1 interacts with a retroreflective item 80. As shown in FIGS. 9 and 10, when incident light photons/rays 10 hit the retroreflective item 80, the retroreflective coating or layer 81 causes the incident light photons/rays 10 to be reflected at the same angle but in the opposite direction towards the source of the incident light photons/rays 10 (i.e., the headset 1) as returning light photons/rays 30. In FIG. 9, there is a large observation angle 40 between the direction that the user's eyes 15 are directed, and the retroreflective item 80. The large observation angle 40 may place the retroreflective item 80 outside of the user's peripheral field of vision, so the user will not be able to see returning light photons/rays 30 being reflected off the retroreflective item 80. On the other hand, in FIG. 10, there is a small observation angle 35 between the direction that the user's eyes 15 are directed, and the retroreflective item 80. In this scenario, the user will be able to see returning light photons/rays 30, and the retroreflective item 80 will appear to glow.

While several variations of the present disclosure have been illustrated by way of example in preferred or particular embodiments, it is apparent that further embodiments could be developed within the spirit and scope of the present disclosure, or the inventive concept thereof. However, it is to be expressly understood that such modifications and adaptations are within the spirit and scope of the present disclosure, and are inclusive, but not limited to the following appended claims as set forth below.

What is claimed is:

1. A headset comprising:
a pair of goggles or a pair of glasses connected to either a strap or a pair of arms, and a plurality of light arrays mounted to at least one of the goggles, the glasses, the strap, or the arms.

2. The headset of claim 1, wherein the pair of glasses are connected to the pair of arms, further comprising a cord connected to the pair of arms, wherein the cord comprises a cord adjuster.

3. The headset of claim 1, wherein the pair of glasses are connected to the pair of arms, and each of the light arrays are mounted to the arms by at least one mounting screw.

4. The headset of claim 1, wherein the pair of goggles are connected to the strap, and each of the light arrays are mounted to at least one of the goggles or the strap by a mounting clip.

5. The headset of claim 4, wherein the strap comprises a strap adjuster.

6. The headset claim 1, wherein the light arrays comprise at least one light.

7. The headset of claim 6, wherein the light arrays further comprise a plurality of lights within a single lens.

8. The headset of claim 1, wherein the light arrays comprise a plurality of lights.

9. The headset of claim 1, wherein the light arrays comprise at least one of the following: a power button, a switch, a positive intensity adjuster, a negative intensity adjuster, a toggle, a wireless data connection key, a wireless data connection indicator light, or a camera button.

10. The headset of claim 1 further comprising a camera.

11. The headset of claim 1 further comprising at least one high beam mounted to at least one of the goggles, the glasses, the strap, the arms, or the light arrays.

12. The headset of claim 1 further comprising at least one of the following: a location indicator, a data storage unit, or a radio frequency transmitter or transceiver.

13. A method of using the headset of claim 1 comprising the steps of:
turning at least one light on;
providing at least one retroreflective item; and
directing the headset toward the retroreflective item.

14. The method of claim 13, wherein the headset further comprises a camera connected to the pair of goggles or the pair of glasses and a radio frequency transmitter or transceiver within at least one of the goggles, the glasses, the light arrays for establishing a wireless data connection with a remote storage device, further comprising the steps of:
activating the camera;
establishing a wireless data connection between the headset and a remote storage device, wherein the remote storage device comprises a data storage unit; and
recording or photographing the retroreflective item with the camera, wherein a plurality of video or photo data is produced.

15. The method of claim 14 further comprising the step of transmitting the video or photo data to the remote storage device.

16. The method of claim 15 further comprising the step of transmitting the video or photo data from the remote storage device to a cloud or server based social media distribution site.

17. The method of claim 14 further comprising the step of transmitting the video or photo data directly from the headset to a cloud or server based social media distribution site.

18. The method of claim 13, wherein the retroreflective item or items comprises at least one of the following: a sports ball, a piece of equipment, an aspect of site infrastructure, an article of clothing, or a mask.

19. The method of claim 15 further comprising the step of utilizing a remote controller to perform at least one of the following steps:
turning at least one light on;
activating the camera;
establishing the wireless data connection between the camera and the remote storage device;
recording or photographing the retroreflective item with the camera; or
transmitting the video or photo data to the remote storage device;
wherein the remote controller comprises at least one of the following: a power button, a switch, a positive intensity adjuster, a negative intensity adjuster, a toggle, a wireless data connection key,
a wireless data connection indicator light, or a camera button.

20. The method of claim 18 further comprising the step of using the headset and at least one retroreflective item at a sports event under low light or no light conditions, which allows for added play value for eventparticipants and spectators.
